(19) United States
(12) Patent Application Publication
(10) Pub. No.: US 2002/0148574 A1
(43) Pub. Date: Oct. 17, 2002

(54) Method of utilizing pulp and paper industry wastes

(76) Inventors: Arlen Van Draanen, Bellevue, WA (US); Steven Mello, Bedford, NH (US)

Correspondence Address: Valarie B. Rosen, Choate, Hall & Stewart, 53 State Street, Exchange Place, Boston, MA, 02109, US

(21) Appl. No.: 09/833,408

(22) Filed: Apr. 11, 2001

(51) Int. Cl. D01C 1/00; D21B 1/00; A23K 1/00

(52) U.S. Cl. 162/14; 162/1; 127/43; 127/46.1; 127/44; 423/540; 423/555; 426/53

(57) ABSTRACT

A method of producing useful products, for example, gypsum and sugar products, from pulp and paper industry wastes.

### FIELD OF THE INVENTION

The present invention relates to a method of producing useful products from pulp and paper industry wastes. More particularly, the present invention relates to a method of producing sugars and gypsum through the concentrated acid hydrolysis of waste materials generated in the pulp and paper industry for direct use or further processing into derivative products.

### BACKGROUND OF THE INVENTION

The pulp and paper industry generates substantial quantities of waste materials in the production of consumer and industrial products. These waste materials are typically disposed of at significant cost and, depending on the disposal method employed, can present long-term environmental liabilities to the waste generator. Although unsuitable for the production of pulp and paper products, these waste materials can contain significant quantities of cellulose, hemicellulose and calcium. Therefore, an environmentally responsible method to cost effectively recover these materials for the production of useful products would be of great benefit to the pulp and paper industry.

Cellulose comprises long chains of beta glucosidal residues linked through the 1,4 positions. These linkages impart high crystallinity and low accessibility to enzymes or acid catalysts. Hemicellulose is an amorphous hetero-polymer which is easily hydrolyzed. Lignin, an aromatic three-dimensional polymer, is interspersed among cellulose and hemicellulose and cannot be hydrolyzed.

Previously reported methods for hydrolyzing cellulose include biological and non-biological means of de-polymerization. The biological methods involve the use of cellulase enzymes which to date have been cost prohibitive to effect hydrolysis economically. Acid hydrolysis is the most common non-biological method to form sugars from cellulosic materials. Although a variety of acids can be used to affect hydrolysis, the most common acid used is sulfuric acid. Sulfuric acid hydrolysis is typically categorized as either dilute acid hydrolysis or concentrated acid hydrolysis.

Dilute acid processes typically use 0.5% to 10% sulfuric acid to hydrolyze cellulose bearing materials. In addition, temperatures from 100°-600° C. at pressures as great as 800 p.s.i. are necessary to effect hydrolysis in dilute acid environments. Dilute acid approaches to hydrolysis have been pursued to minimize the costs associated with the consumption of sulfuric acid. Reduced acid operating costs, however, are offset by the significantly higher capital costs associated with the metallurgy and pressure requirements of vessels to effect hydrolysis at elevated temperatures and pressures in an acidic environment. Further, at high temperatures and pressures, sugars degrade to form furfural and other undesirable by-products and glucose yields realized are generally low. As a result of these factors, dilute acid approaches to the hydrolysis of cellulosic materials have not been successful in obtaining sugars economically.

Concentrated acid processes typically involve the use of 60% to 90% sulfuric acid to effect de-crystallization with further dilution of acid typically below 50% to effect hydrolysis. Although producing sugar at higher yield than dilute acid approaches, concentrated acid hydrolysis has not been commercially implemented due to the high costs associated with separating and recovering acid for re-use.

Regardless of the hydrolysis approach taken, it would be desirable to hydrolyze pulp and paper industry waste to produce sugars. These sugars could then be utilized for fermentation or further chemical processing. There are numerous industrial and household chemicals, which can be manufactured from sugars, and it is desirable to reduce the costs associated with the manufacture of these materials. To date, no commercially viable process for the hydrolysis of pulp and paper industry wastes, either with biological or non-biological approaches, exists.

Gypsum is a naturally occurring mineral with the composition CaSO₄.2H₂O. In ancient times, it was discovered that gypsum could be ground and heated, or calcined, until it was largely free of moisture. Calcined gypsum, commonly known as stucco or Plaster of Paris, when re-mixed with water, creates a pliable mortar that can be shaped before hardening. Gypsum is typically mined for the production of gypsum products. Alternatively, byproduct gypsum for use in manufacturing gypsum products has been produced through flue gas de-sulfurization, primarily in power generating facilities. Gypsum can also be produced through the neutralization of sulfuric acid with lime and lime bearing materials. It is desirable to have an inexpensive source of waste or byproduct gypsum to reduce the costs associated with the manufacture of gypsum products.

Thus, there is a need for an economically viable and environmentally safe process for producing sugars from pulp and paper industry wastes while also producing low cost byproduct gypsum for the efficient production of gypsum products.

### SUMMARY OF THE INVENTION

In one aspect, the invention is a method of producing sugars and gypsum from pulp and paper industry wastes. The method comprises mixing pulp and paper industry wastes with acid to neutralize any non-cellulosic acid reactive materials therein and at least partially de-crystallize cellulose and hemicellulose to form a gel that includes a solid material and a liquid portion, diluting the gel to an acid concentration between about 10% and about 60% by weight, heating the diluted gel to partially hydrolyze cellulose and hemicellulose contained therein, separating the gel into an acidic liquid portion and a solid portion, neutralizing the acidic liquid portion to precipitate a first gypsum byproduct, and separating the neutralized liquid portion from the first gypsum byproduct. The method may further comprise pre-treating the pulp and paper industry wastes. Pre-treating may comprise drying the pulp and paper industry wastes, for example, to a moisture content between about 5% and about 40% by weight, for example, between about 10% and about 15%. Pre-treating may comprise commuting the pulp and paper industry wastes to particles having a size between about 0.05 mm and about 20 mm, for example, to a size of about 5 mm. In another embodiment, pre-treating may comprise combining the pulp and paper industry wastes with a solution of sodium hydroxide to at least partially dissolve silica therein. Pre-treating may also comprise combining the pulp and paper industry wastes with a ketone to at least partially dissolved lignin.

The acid may have an initial concentration of about 20%-100%, for example, between about 70% and about 80%. The ratio of acid to cellulose and hemicellulose may be between about 0.75:1 and about 5:1, for example, about 1.3:1. The step of heating may comprise heating the diluted the gel to a temperature between about 50° C. and about 100° C., for example, between about 85° C. and about 95° C. The step of diluting may comprise diluting the acid to a concentration between about 20% and about 30% by weight. The method may further comprise bringing the acid-wastes mixture to a temperature between about 30° C. and about 80° C., for example, between about 40° C. and about 50° C., following the step of mixing.

The step of heating may be performed for a period between about 15 minutes and about 600 minutes, for example, between about 60 minutes and about 180 minutes. The pressure during either mixing or heating may be between about 400 mm Hg vacuum and about 300 psi, for example, at atmospheric pressure. The method may further comprise repeating the steps of mixing, diluting, heating, separating, and neutralizing with the solid portion.

The step of neutralizing may comprise combining the acidic liquid portion with a calcium-bearing or non-calcium bearing material. Sufficient base material may be added to the acidic liquid portion to achieve a concentration between 0.10 and 0.5 molar, for example, between 0.75 and 0.95 molar. The method may further comprise recovering a resulting carbon dioxide byproduct. The base material may comprise calcium oxide, calcium hydroxide, calcium carbonate, or any combination of the other. The method may further comprise calcining and hydrating calcium carbonate to produce calcium oxide or calcium hydroxide. The steps of calcining and hydrating may result in a calcium-bearing grit, and the method may further comprise combining the calcium-bearing grit with the first gypsum byproduct to produce a combined gypsum byproduct.

A pH of the neutralized liquid portion may be between 0.1 and 13.5, for example, 5.5. The step of neutralization may be conducted at a temperature between about 20° C. and about 150° C., for example, 50° C. The method may further comprise combusting the solid portion to generate heat and a residue. The method may further comprise combining the residue with the first gypsum byproduct to form a combined gypsum byproduct. The heat may be utilized in the steps of mixing, diluting, heating, separating, or neutralizing. Additionally, the heat may be used to pre-treat the pulp and paper wastes, calcine calcium carbonate to produce calcium oxide or calcium hydroxide, heat the undiluted gel, process a gypsum byproduct, sterlizie or concentrate a sugar-containing liquid, concentrate a liquid containing a sugar product, evaporate a liquid to crystallize a solute dissolved therein, dry a sugar product, or heat a mixture of a fermentation agent and a sugar-containing liquid.

The acid may be sulfuric acid, and the method may further comprise producing sulfuric acid, for example, by combusting sulfur. Sulfuric acid may also be produced by processing sulfur-bearing gases, liquids, or solids. Combustion or other production methods may result in a sulfurous gas byproduct, and the method may further comprise passing the sulfurous gas byproduct through a scrubber containing a calcium-bearing base material to form a used scrubber material, and combining the used scrubber material with the first gypsum byproduct to form a combined gypsum byproduct.

The method may further comprise passing the neutralized liquid portion through a cation exchange resin, sterilizing the cation exchanged liquid portion, incubating the sterilized liquid portion with a fermentation agent, separating the liquid portion from the used fermentation agent, combining the fermented liquid portion with a calcium-bearing base material to produce a calcium salt and a waste water product, combining the calcium salt with sulfuric acid to produce a solution of a sugar product and a second gypsum byproduct, and purifying and crystallizing the sugar product. The method may further comprise combining the waste water portion with an anaerobic agent to produce a biogas and combusting the biogas to produce heat. The method may also further comprise combining the first gypsum byproduct and the second gypsum byproduct to produce a combined gypsum byproduct and/or combusting the used fermentation agent to produce heat. The method may further comprise combining mined gypsum or industrial calcium-bearing waste materials with the first gypsum byproduct.

### BRIEF DESCRIPTION OF THE FIGURES

The invention is described with reference to the several figures of the drawing, in which,

FIG. 1 is a process diagram illustrating the preparation of pulp and paper industry wastes to produce sugar and gypsum.

FIG. 2 is a process diagram illustrating the decrystallization, hydrolysis and further processing of pulp and paper industry wastes to produce sugar and gypsum.

FIG. 3 is a process diagram illustrating the production of gypsum products and sugar products from pulp and paper industry wastes. The figure illustrates the full integration of the process and the contribution of materials integration and the energy recovery from process wastes.

FIG. 4 is a process diagram of one embodiment of the invention illustrating the production of a particular sugar product, citric acid.

FIG. 5 is a process diagram of one embodiment of the invention illustrating the production of particular gypsum products, gypsum wallboard and plaster.

### DETAILED DESCRIPTION OF THE INVENTION

### Definitions

While not be construed as limiting, the terms used herein have the following definitions unless indicated otherwise:

“About” is used to indicate that a value such as a temperature or weight percent need not be completely precise. One skilled in the art will recognize that such a value may be varied within an acceptable range without thwarting the goals of the invention. Routine experimentation will demonstrate the extent to which a value may be varied while still successfully conducting the processes of the invention.

“Calcium-bearing byproducts” are byproduct materials, generally produced in industrial manufacturing processes, which contain calcium and include, without limitation, slaker grit and green liquor dregs.

“Gypsum” is calcium sulfate in any state of hydration or dehydration, which meets any typical minimum purity specification for mined or naturally occurring gypsum utilized to manufacture any gypsum product, but, in any case, is suitable for the manufacture of one or more gypsum products.

“Gypsum products” are those products typically produced from gypsum, including without limitation, cement, clay, fertilizer, glass, gypsum wallboard, kitchenware, matches, plaster, and toothpaste.

“Heat” is any method of raising the temperature of any material for any purpose and includes, without limitation, the use of steam, electricity, solar or other alternative energy or the direct fire of a fossil or other fuel.

“Pulp and paper industry wastes” are materials generated in the pulp and paper industry which are not suitable for the production of pulp and/or paper and include, without limitation, pulp and paper mill primary clarifier sludge, pulp and paper mill primary clarifier sludge mixed with pulp and paper mill secondary clarifier sludge, wastes from processing old corrugated containers (OCC's) and wastes from de-ink pulp mill operations.

“Pre-treatment” means the pre-treatment of pulp and paper industry wastes to at least partially remove materials other than cellulose and hemicellulose that may be present therein, including, without limitation, washing the pulp and paper industry wastes with water, base, acid or solvent either directly or in a slurry, recovering or removing metals with a magnet or other device, recovering or removing non-ferrous metals with a nonferrous metal recovery system, recovering or removing plastic through air separation, flotation or other device, treatment with caustic soda or other suitable base to solubilize silica preferably for subsequent processing and recovery, pelletizing, grinding, shredding, hammermilling, screening, sizing, sorting, trommeling, picking, and/or re-slurrying the pulp and paper industry wastes. Any pre-treatment process may occur in any order with respect to any other pre-treatment process and may be selected based on the particular characteristics of a particular pulp and paper industry waste source.

“Separation” means to at least partially physically separate two phases, for example, a solid from a liquid, including, without limitation centrifuging, filtering, pressing, decanting, and/or settling utilizing any physical means to realize such separation including without limitation, gravity, pressure or vacuum.

“Sugar” includes glucose, xylose, and other mono or polysaccharides, including those derived through the hydrolysis of cellulose and hemicellulose found in any pulp and paper industry wastes and includes glucose and xylose.

“Sugar products” are those products derived through the fermentation or chemical processing of sugar, including without limitation, sugar esters, acetic acid, acetone, butandiol, butanol, butyric acid, citric acid, ethanol, ethyl acetate, fumaric acid, gluconic acid, glycerol, isopropyl alcohol, itaconic acid, lactic acid, levulinic acid, lysine, propanol, 1,3 propanediol, propionic acid, sorbitol, succinic acid, tryptophan, xanthum gum, xylitol and/or their respective derivatives.

### Introduction

This invention provides an improved process for producing sugars and gypsum from pulp and paper industry wastes using concentrated sulfuric acid. The process of the present invention provides a means for producing sugars and gypsum from pulp and paper industry wastes, which also reduces the amount of waste product and effluents produced. The process is designed to reuse almost all aqueous streams and to convert all solids to saleable products. In the portion of the process involving the production of sugar products, both C₅ and C₆ sugars can be utilized. Key to the overall economic feasibility of the current invention is the production of sugar and gypsum of sufficient quality for sale or use to produce sugar products and gypsum products. In addition, the efficient use of waste streams for process energy requirements, the inclusion of combusted residues and scrubber gypsum in the production of gypsum for gypsum products, and the production integration of sulfuric acid and lime also contribute to the economic feasibility of the current invention. Other features of the present invention, which contribute to its efficiency and economic feasibility, include the recovery and purification of by-product carbon dioxide and the utilization of biogas derived from process wastewater in the manufacture of certain gypsum products and/or process raw materials. In addition, the use of atmospheric pressure and relatively low temperatures contributes to the overall efficiency of the process by obviating the use of exotic and expensive materials of construction. Finally, the process does not result in the production of furfural and similar undesirable toxic by-products that can inhibit fermentation.

As will be explained more fully below, the process of the present invention provides an efficient, cost-effective means of producing sugar and sugar products and gypsum and gypsum products from the hydrolysis of pulp and paper industry wastes while at the same time producing little or no waste effluents or materials.

The examples which follow are illustrative of the process of the present invention. The values given may be varied according to measurement errors acceptable to those skilled in the art.

### Pulp and Paper Industry Wastes Pre-treatment

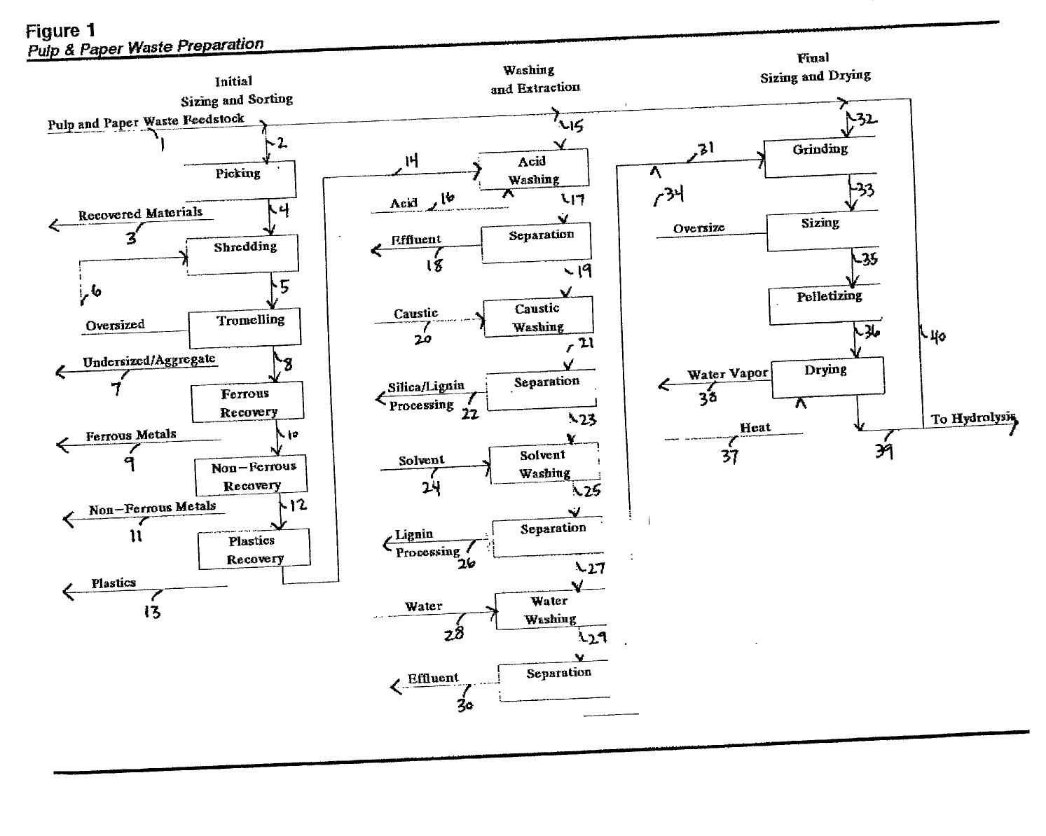

Pulp and paper industry wastes have varied characteristics. In limited instances, particular pulp and paper industry wastes may be utilized directly for decrystallization, hydrolysis and further processing without any pretreatment. However, it is normally preferable to subject most pulp and paper industry wastes to some sort of pretreatment. Generally, as indicated in FIG. 1, the pretreatment of pulp and paper industry wastes falls into three general areas: initial sizing and sorting, washing and extraction, and final sizing and drying. The following examples are illustrative of the pretreatment of pulp and paper industry wastes, and each example is intended to be merely exemplary in nature.

### EXAMPLE 1

In this example, pulp and paper mill primary clarifier underflow is utilized as a source of pulp and paper industry wastes and is subject to de-watering and final sizing and drying. Referring to FIG. 1, the pulp and paper industry wastes 1 is first directed 29 to separation where it is dewatered. The de-watered pulp and paper industry waste is then optionally directed 31 to a grinder where size is reduced to between 0.05 mm and 20 mm but preferably 5 mm. The ground pulp and paper industry wastes 33 is then optionally directed over a screen or other sizing device, with oversized material 34 being optionally redirected to grinding. The sized pulp and paper industry wastes 35 may then optionally be directed to a pelletizer where the material may be sized, as required for storage, materials handling or other process requirements. The optionally pelletized material, 36 is then directed to a dryer where heat 37 is introduced and water vapor 38 is removed. The final dried product 39 preferably with a moisture content of between 5 and 20% and more preferably about 10%, is then directed to hydrolysis.

### EXAMPLE 2

In this example, mixed primary and secondary clarifier underflow is utilized as a source of pulp and paper industry wastes and is subject to de-watering and final sizing and drying. Referring to FIG. 1, the pulp and paper industry waste 1 is first directed 29 to separation where it is dewatered. The de-watered pulp and paper industry waste is then optionally directed 31 to a grinder where size is reduced to between 0.05 mm and 20 mm but preferably 5 mm. The ground pulp and paper industry waste 33 is then optionally directed over a screen or other sizing device, with oversized material 34 being optionally redirected to grinding. The sized pulp and paper industry wastes 35 may then optionally be directed to a pelletizer where the material may be sized, as required for storage, materials handling or other process requirements. The optionally pelletized material, 36 is then directed to a dryer where heat 37 is introduced and water vapor 38 is removed. The final dried product 39 preferably with a moisture content of between 5 and 20% and more preferably about 10%, is then directed to hydrolysis.

### EXAMPLE 3

In this example, residue from processing old corrugated containers is utilized as a source of pulp and paper industry waste and is subject to shredding, trommeling, ferrous recovery, non-ferrous recovery, plastics recovery, final sizing and drying. Referring to FIG. 1, the pulp and paper industry waste 1 is first directed 4 is to shredding where the size is reduced preferably between 2 and 6 inches before being directed 5 to a trommel or other sizing device where the material is segregated by size. Oversized material 6 may be optionally directed to shredding with undersized material 7 optionally being directed to further processing and recovery. The sized material 8 is then optionally directed to ferrous recovery, where ferrous metals are at least partially removed with the use of a magnet or other suitable device. The ferrous metals 9 are directed to further processing, recovery or sale with the treated pulp and paper industry wastes 10 optionally directed to non-ferrous recovery for the removal of non-ferrous metals 11, which are also directed for further processing, recovery or sale. The treated pulp and paper industry waste 12 is then optionally directed to plastics recovery where plastics are removed with an air knife, by flotation or other suitable device and the plastics 13 directed to further processing, recovery or sale. The initially sized and sorted pulp and paper industry waste 14 is directed 32 to a grinder where size is reduced to between 0.05 mm and 20 mm but preferably 5 mm. The ground pulp and paper industry wastes 33 is then optionally directed over a screen or other sizing device, with oversized material 34 being optionally redirected to grinding. The sized pulp and paper industry wastes 35 may then be directed to a pelletizer where the material may be sized, as required for storage, materials handling or other process requirements. The optionally pelletized material 36 is then directed to a dryer where heat 37 is introduced and water vapor 38 is removed. The final dried product 39, preferably with a moisture content of between 5 and 20% and more preferably about 10%, is then directed to hydrolysis.

### EXAMPLE 4

In this example, residue from a de-ink pulp mill is utilized as a source of pulp and paper industry wastes and is subject only to final sizing and drying. Referring to FIG. 1, the pulp and paper industry waste 1 is first optionally directed 32 to a grinder where size is reduced to between 0.05 mm and 20 mm but preferably 5 mm. The ground pulp and paper industry wastes 33 is then optionally directed over a screen or other sizing device, with oversized material 34 being optionally redirected to grinding. The sized pulp and paper industry wastes 35 may then optionally be directed to a pelletizer where the material may be sized, as required for storage, materials handling or other process requirements. The optionally pelletized material 36 is then directed to a dryer where heat 37 is introduced and water vapor 38 is removed. The final dried product 39 preferably with a moisture content of between 5 and 20% and more preferably about 10%, is then directed to hydrolysis.

### Pulp and Paper Industry Wastes Hydrolysis for Conversion to Sugar and Gypsum

### EXAMPLE 5

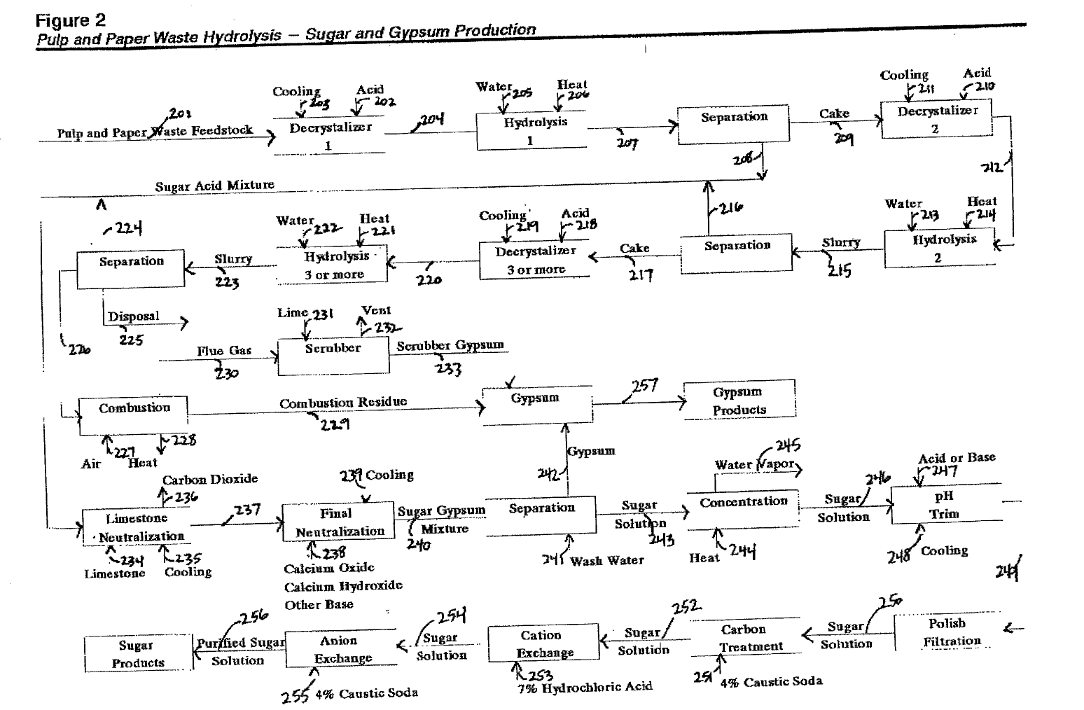

As seen in FIG. 2, pulp and paper industry waste feedstock 201, prepared according to any of the above examples, is fed to a decrystalizer mixer with sulfuric acid 202. The acid concentration utilized is 20-100% and more preferably 70-80%, with the quantity of acid added to achieve a ratio of pure acid to cellulosic and hemicellulosic material of at least 0.75:1 but not more than 5:1. More preferably, the ratio achieved, after neutralizing any acid reactive material in the pulp and paper industry wastes is about 1.3:1. During de-crystallization, the temperature is maintained with cooling 203 between 30°-90° C. but preferably under 50° C. The decrystallized pulp and paper industry wastes gel 204 is then diluted with water 205 to a final acid concentration between 10% and 60% but more preferably about 25%. The diluted mixture is preferably transferred to a dedicated hydrolysis reactor and heated 206 to between 50°-100° C., but preferably to about 95° C. for a period of between 15 and 600 minutes, but preferably about 90 minutes at a pressure of between 400 mm Hg vacuum and 300 psi but preferably at atmospheric pressure. Upon preferably maximizing the conversion of pulp and paper industry wastes to sugars in this hydrolysis, the slurry 207 is subject to separation with the acid sugar mixture 208 directed to further processing. The solid cake 209 is then directed to a second hydrolysis where the material is decrystallized again with the addition of sulfuric acid 210 and cooling 211. The gel material 212 is then subject to hydrolysis with the addition of water 213 and heat 214. The acid concentration and physical conditions for the second decrystallization and hydrolysis are preferably approximately the same as those in the first hydrolysis. Upon preferably maximizing the conversion of remaining pulp and paper industry waste to sugar in this hydrolysis, the slurry 215 is subject to separation with the acid sugar mixture 216 directed to further processing. The solid cake 217 is then directed to a third hydrolysis where the material is decrystallized again with the addition of sulfuric acid 218 and cooling 219. The gel material 220 is then subject to hydrolysis with the addition of water 222 and heat 221. The acid concentration and physical conditions for the third decrystallization and hydrolysis are preferably approximately the same as those in the second hydrolysis. Upon preferably maximizing the conversion of remaining pulp and paper industry waste to sugar in this hydrolysis, the slurry 223 is subject to separation with the acid sugar mixture 224 directed to further processing. The solid cake can then be directed to subsequent stages of decrystallization and hydrolysis, to disposal 225 or preferably to combustion 226. The solid cake when directed to combustion with the introduction of air 227 produces heat 228 which is preferably recovered and directed to process energy requirements. The residue from combustion 229 is preferably directed to be combined with process gypsum streams and directed 257 to the production of gypsum products. Flue gas 230, produced in the combustion of residue 226 is preferably scrubbed to reduce sulfur emissions. This reduction can best be realized with the introduction of lime 231 with the resulting gypsum 233 also being directed for combination with process gypsum streams and directed 257 to the production of gypsum products. The acid sugars streams 208, 218, and 224 collected from the separation of solid cake after each stage of hydrolysis are preferably combined for neutralization. These materials are neutralized, preferably in a dedicated neutralization reactor, first with limestone 234 which is preferably prepared as 325 mesh or finer particle size as a dry powder or as an aqueous slurry. The prepared limestone is used to neutralize sulfuric acid on a 0.10 to 3.50 molar basis, but preferably on a 0.75 to 0.95 molar basis at a temperature of between 20°-100° C. but preferably at about 50° C. over a period of 20 to 600 minutes but preferably about 60 minutes. Carbon dioxide 236 generated during neutralization is preferably captured, scrubbed and compressed for sale. Upon completion of the limestone neutralization, the slurry 237 is then preferably subject to final neutralization with calcium oxide, calcium hydroxide or other suitable base 238 to adjust the pH to between 2.5 and 13.5 but preferably to about 5.5. Upon completion of the neutralization, the sugar gypsum mixture 240 is subject to separation with the gypsum 242, preferably after washing 241, directed preferably to be combined with other process gypsum streams for sale or for production of gypsum products. The sugar solution 243 is then directed optionally to a multiple effect evaporator where water vapor 245 is removed through the addition of heat 244, preferably under vacuum. The sugar solution is optionally concentrated to that level required for sale or use in the production of sugar products, typically between 10% and 65%. The concentrated sugar solution 246 is then optionally subject to pH trim with addition of an acid or base 247 preferably with cooling 248. The solution 249 is then optionally subject to polish filtration. The filtered solution 250 is then optionally treated with carbon with the carbon preferably periodically regenerated with a solution of caustic soda 251. The carbon treated sugar solution 252 is optionally subject to cation exchange with the cation exchange resin periodically regenerated with a solution of hydrochloric acid 253. The de-cationized sugar solution 254 is then optionally subject to anion exchange with the anion exchange resin periodically regenerated with a solution of caustic soda 252. The purified sugar 256 is then directed to sale or to the production of sugar products.

### EXAMPLE 6

As seen in FIG. 2, pulp and paper industry wastes feedstock 201 prepared according to any of the above examples, is fed to a decrystalizer mixer with sulfuric acid 202. The acid concentration utilized is 20-100% and more preferably 70-80% with the quantity of acid added to achieve a ratio of pure acid to cellulosic and hemicellulosic material of at least 0.75:1 but not more than 5:1. More preferably, the ratio achieved, after neutralizing any acid reactive material in the pulp and paper industry wastes is about 1.3:1. During de-crystallization, the temperature is maintained with cooling 203 between 30°-90° C. but preferably under 50° C. The decrystallized pulp and paper industry wastes gel 204 is then diluted with water 205 to a final acid concentration between 10% and 60% but more preferably about 25%. The diluted mixture is preferably transferred to a dedicated hydrolysis reactor and heated 206 to between 50°-100° C., but preferably to about 95° C. for a period of between 15 and 600 minutes, but preferably about 90 minutes at a pressure of between 400 mm Hg vacuum and 300 psi but preferably at atmospheric pressure. Upon preferably maximizing the conversion of pulp and paper industry wastes to sugars in this hydrolysis, the slurry 207 is subject to separation with the acid sugar mixture 208 directed to further processing. The solid cake 209 is then directed to a second hydrolysis where the material is decrystallized again with the addition of sulfuric acid 210 with cooling 211. The gel material 212 is then subject to hydrolysis with the addition of water 213 with heat 214. The acid concentration and physical conditions for the second decrystallization and hydrolysis are preferably approximately the same as those in the first hydrolysis. Upon preferably maximizing the conversion of remaining pulp and paper industry wastes to sugar in this hydrolysis, the slurry 215 is subject to separation with the acid sugar mixture 216 directed to further processing. The solid cake can then be directed to disposal 225 or preferably to combustion 226. The solid cake when directed to combustion with the introduction of air 227 produces heat 228, which is preferably recovered and directed to process energy requirements. The residue from combustion 229 is preferably directed to be combined with process gypsum streams and directed 257 to the production of gypsum products. Flue gas 230, produced in the combustion of residue 226, is preferably scrubbed to reduce sulfur emissions. This reduction can best be realized with the introduction of lime 231 with the resulting gypsum 233 also being directed for combination with process gypsum streams and directed 257 to the production of gypsum products. The acid sugars streams 208 and 218 collected from the separation of solid cake after each stage of hydrolysis are preferably combined for neutralization. These materials are neutralized, preferably in a dedicated neutralization reactor, first with limestone 234, which is preferably prepared as 325 mesh or finer particle size as a dry powder or as an aqueous slurry. The prepared limestone is used to neutralize sulfuric acid on a 0.10 to 3.5 molar basis, but preferably on a 0.75 to 0.95 molar basis at a temperature of between 20°-100° C. but preferably at about 50° C. over a period of 20 to 600 minutes but preferably about 60 minutes. Carbon dioxide 236 generated during neutralization is preferably captured, scrubbed and compressed for sale. Upon completion of the limestone neutralization, the slurry 237 is then preferably subject to final neutralization with calcium oxide, calcium hydroxide or other suitable base 238 to adjust the pH to between 2.5 and 13.5 but preferably to about 5.5. Upon completion of the neutralization, the sugar gypsum mixture 240 is subject to separation with the gypsum 242, preferably after washing 241, directed preferably to be combined with other process gypsum streams for sale or for production of gypsum products. The sugar solution 243 is then directed optionally to a multiple effect evaporator where water vapor 245 is removed through the addition of heat 244 preferably under vacuum. The sugar solution is optionally concentrated to that level required for sale or use in the production of sugar products typically between 10% and 65%. The concentrated sugar solution 246 is then optionally subject to pH trim with addition of an acid or base 247, preferably with cooling 248. The solution 249 is then optionally subject to polish filtration. The filtered solution 250 is then optionally treated with carbon with the carbon preferably periodically regenerated with a solution of caustic soda 251. The carbon treated sugar solution 252 is optionally subject to cation exchange with the cation exchange resin periodically regenerated with a solution of hydrochloric acid 253. The de-cationized sugar solution 254, is then optionally subject to anion exchange with the anion exchange resin periodically regenerated with a solution of caustic soda 255. The purified sugar 256 is then directed to sale or to the production of sugar products.

### EXAMPLE 7

As seen in FIG. 2, pulp and paper industry wastes feedstock 201, prepared according to any of the above examples is fed to a decrystalizer mixer with sulfuric acid 202. The acid concentration utilized is 20-100% and more preferably 70-80% with the quantity of acid added to achieve a ratio of pure acid to cellulosic and hemicellulosic material of at least 0.75:1 but not more than 5:1. More preferably, the ratio achieved, after neutralizing any acid reactive material in the pulp and paper industry wastes is about 1.3:1. During de-crystallization, the temperature is maintained with cooling 203 between 30°-90° C. but preferably under 50° C. The decrystallized pulp and paper industry wastes gel 204 is then diluted with water 205 to a final acid concentration between 10% and 60% but more preferably about 25%. The diluted mixture is preferably transferred to a dedicated hydrolysis reactor and heated 206 to between 50°-100° C., but preferably to about 95° C. for a period of between 15 and 600 minutes, but preferably about 90 minutes at a pressure of between 400 mm Hg vacuum and 300 psi but preferably at atmospheric pressure. Upon preferably maximizing the conversion of pulp and paper industry wastes to sugars in this hydrolysis, the slurry 207 is subject to separation with the acid sugar mixture 208 directed to further processing. The solid cake can then be directed to disposal 225 or preferably to combustion 226. The solid cake when directed to combustion with the introduction of air 227 produces heat 228, which is preferably recovered and directed to process energy requirements. The residue from combustion 229 is preferably directed to be combined with process gypsum streams and directed 257 to the production of gypsum products. Flue gas 230, produced in the combustion of residue 226, is preferably scrubbed to reduce sulfur emissions. This reduction can best be realized with the introduction of lime 231, with the resulting gypsum 233 also being directed for combination with process gypsum streams and directed 257 to the production of gypsum products. The acid sugars streams 208 and 218 collected from the separation of solid cake after each stage of hydrolysis are preferably combined for neutralization. These materials are neutralized, preferably in a dedicated neutralization reactor, first with limestone 234, which is preferably prepared as 325 mesh or finer particle size as a dry powder or as an aqueous slurry. The prepared limestone is used to neutralize sulfuric acid on a 0.10 to 3.5 molar basis, but preferably on a 0.75 to 0.95 molar basis at a temperature of between 20°-100° C. but preferably at about 50° C. over a period of 20 to 600 minutes but preferably about 60 minutes. Carbon dioxide 236 generated during neutralization is preferably captured, scrubbed and compressed for sale. Upon completion of the limestone neutralization, the slurry 237 is then preferably subject to final neutralization with calcium oxide, calcium hydroxide or other suitable base 238 to adjust the pH to between 2.5 and 13.5 but preferably to about 5.5. Upon completion of the neutralization, the sugar gypsum mixture 240 is subject to separation with the gypsum 242, preferably after washing 241, directed preferably to be combined with other process gypsum streams for sale or for production of gypsum products. The sugar solution 243 is then directed optionally to a multiple effect evaporator where water vapor 245 is removed through the addition of heat 244, preferably under vacuum. The sugar solution is optionally concentrated to that level required for sale or use in the production of sugar products typically between 10% and 65%. The concentrated sugar solution 246 is then optionally subject to pH trim with addition of an acid or base 247, preferably with cooling 248. The solution 249 is then optionally subject to polish filtration. The filtered solution 250 is then optionally treated with carbon with the carbon preferably periodically regenerated with a solution of caustic soda 251. The carbon treated sugar solution 252 is optionally subject to cation exchange with the cation exchange resin periodically regenerated with a solution of hydrochloric acid 253. The de-cationized sugar solution 254 is then optionally subject to anion exchange with the anion exchange resin periodically regenerated with a solution of caustic soda 255. The purified sugar 256 is then directed to sale or to the production of sugar products.

### Gypsum Blending and Facility Integration

### EXAMPLE 8

This example presents the process of combining gypsum produced through the hydrolysis of pulp and paper industry wastes with other gypsum and calcium-bearing materials for sale or for the production of gypsum products. This example also demonstrates the beneficial impact to the process through the integration of key raw materials as well as generation of process heat requirements through the combustion of certain process residue. This example is intended to merely be exemplary in nature.

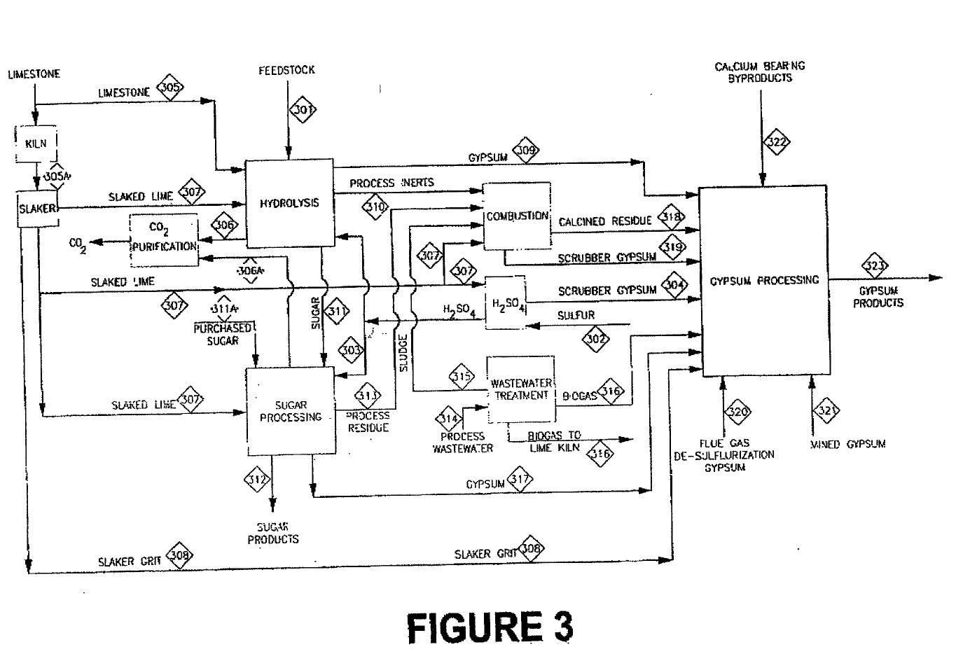

As seen in FIG. 3, pulp and paper industry wastes feedstock 301 is decrystallized and hydrolyzed with sulfuric acid 303, preferably produced through the combustion of sulfur 302. The heat generated by the combustion of sulfur 302 is preferably utilized for process energy requirements. Upon completion of hydrolysis, process inerts 310, are subject to separation and preferably directed to combustion and heat recovery for process energy requirements. Limestone 305 and slaked lime 307 are ground and preferably slurried in an aqueous system and utilized for neutralization of acid used in hydrolysis, for purification of sugar products and for scrubbing of sulfur-bearing process flue gases. Carbon dioxide 306 generated in the neutralization of sulfuric acid with limestone along with carbon dioxide 306a, from the production of sugar products, is vented or preferably collected, scrubbed and compressed for sale. Gypsum 309 formed in the neutralization of sulfuric acid after hydrolysis is directed to gypsum processing. Sugars 311, after separation from gypsum, are directed to sugar processing. As more fully described in Example 9 herein below, the sugars can be optionally combined with purchased sugar 311a and are preferably processed to manufacture sugar products. The production of sugar products can also generate gypsum 317, which is preferably directed to gypsum processing. In addition to gypsum 317, the production of sugar products also generates process residue 313, which is preferably directed to combustion and heat recovery for process energy requirements. In this example, process wastewater 314 from the entire facility is preferably treated anaerobically to generate biogas 316, which is preferably utilized in gypsum processing (as further illustrated in Example 10 herein below) and/or as fuel for the lime kiln used to produce calcium oxide 305a prior to slaking. The byproduct of slaking calcium oxide 305a is slaker grit 308, which is also directed to gypsum processing. The solid sludge from the wastewater treatment plant 315 is preferably directed to combustion and heat recovery (along with the process inerts 310 from hydrolysis and the process residue 313 from sugar processing) for process energy requirements. The presence of sulfur compounds in process flue gas is reduced through the addition of slurried slaked lime 307, which results in the production of gypsum. In this example, gypsum 319 from scrubbing flue gas in the combustion of process residue, as well as gypsum 304 from scrubbing flue gas in the manufacture of sulfuric acid are both directed to gypsum processing. Each of calcium-bearing byproducts 322, mined gypsum 321, and non process flue gas de-sulfurization gypsum 320 may also be directed, either singularly or in any combination, to gypsum processing, where they are combined with other process gypsum streams, preferably to be used for the production of gypsum products 323.

### Sugar Products

### EXAMPLE 9

In this example, citric acid is fermented from sugars produced and isolated through the hydrolysis of pulp and paper industry wastes as indicated in Example 7. The production of citric acid as a sugar product is intended to be merely exemplary in nature.

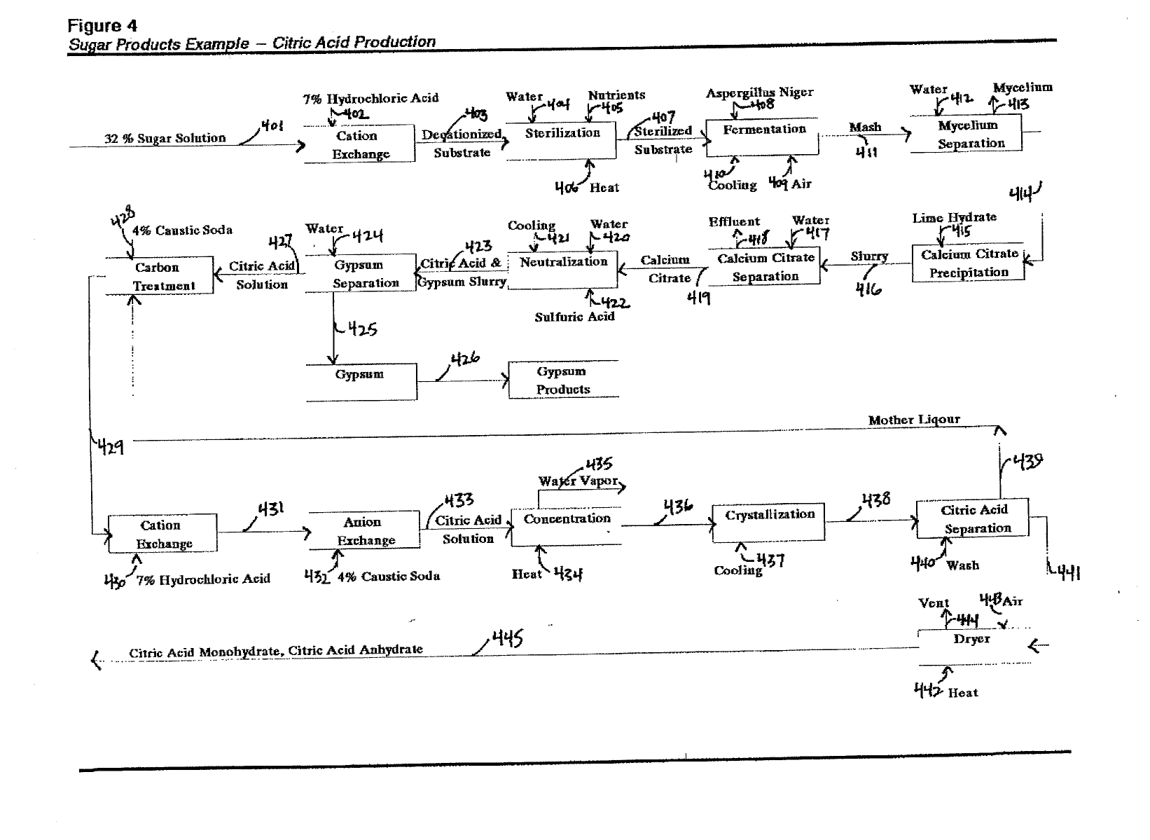

As seen in FIG. 4, the pulp and paper industry wastes hydrolysate is preferably received at a concentration of 32% 401 and is preferably subject to cation exchange. The cation exchange resin is preferably periodically re-generated with hydrochloric acid, 402. The de-cationized sugar substrate 403 is preferably sterilized by heating 406 to approximately 60° C. prior to fermentation. Water 404 and nutrients 405 are then added and the prepared substrate 407 is preferably cooled 410 to about 35° C. before being pumped into a clean, sterile bubble column fermentation reactor. Aspergillus niger spores 408, having previously been prepared are added to the fermentation reactor and compressed air 409, is preferably injected into the fermentation mixture, providing oxygen required for biochemical conversion of the sugar to citric acid. With continuous cooling 410 over a preferred residence time of about five days, the fermentation mash, 411 is evacuated preferably via a heat exchanger, heated to about 85° C. and is subject to separation to remove mycelium, 413. The mycelium is preferably washed with water 412, and the separated mycelium 413 is preferably combusted to contribute to process steam requirements. Aqueous lime hydrate 415 is preferably added to the citric acid broth 414 to precipitate calcium citrate. The calcium citrate slurry 416 is subject to separation with the precipitated calcium citrate being preferably counter-current washed with water 417. The effluent 418 from this process is subject to combination with other process wastewater streams and is preferably treated anaerobically to generate methane gas for process heat requirements. The washed calcium citrate crystals 419 are then preferably neutralized with sulfuric acid 422 in an aqueous system 420, with cooling 421, to produce a solution of citric acid and gypsum 423. The gypsum 425 is subject to separation from the citric acid solution 427, and the gypsum is preferably counter current washed with water 424, with the filtrate preferably being combined with the citric acid solution. The gypsum 425 is preferably conveyed to be combined with other process gypsum streams, 426 for sale or further processing into gypsum products. The citric acid solution 427 is then preferably purified through carbon with the carbon periodically regenerated with caustic soda 428. The carbon treated citric acid solution 429 is then preferably subject to cation exchange with the cation exchange resin being periodically regenerated with hydrochloric acid 430. The de-cationized citric acid solution 431 is then preferably subject to anion exchange with the anion exchange resin being periodically regenerated with caustic soda 432. The purified citric acid solution 433 is then preferably concentrated in a multiple effect evaporator with the use of heat 434 and the concentrated solution 436 cooled 437 to crystallize citric acid. The crystallized citric acid in solution 438 is subject to separation with the mother liquor 439 preferably recycled to the citric acid solution 427 prior to purification. The citric acid crystals 441 are preferably washed 440 and then dried with heat 442 and the introduction of air 443. The final dried product 445 is packaged for sale.

### Gypsum Products

### EXAMPLE 10

In this example, gypsum wallboard and plaster are produced from gypsum combined from sources identified in Example 8. The production of gypsum wallboard and plaster as gypsum products can also be manufactured directly from gypsum isolated from the hydrolysis of pulp and paper industry wastes in Examples 5, 6 and 7. The use of gypsum wallboard and plaster as gypsum products is intended to be merely exemplary in nature.

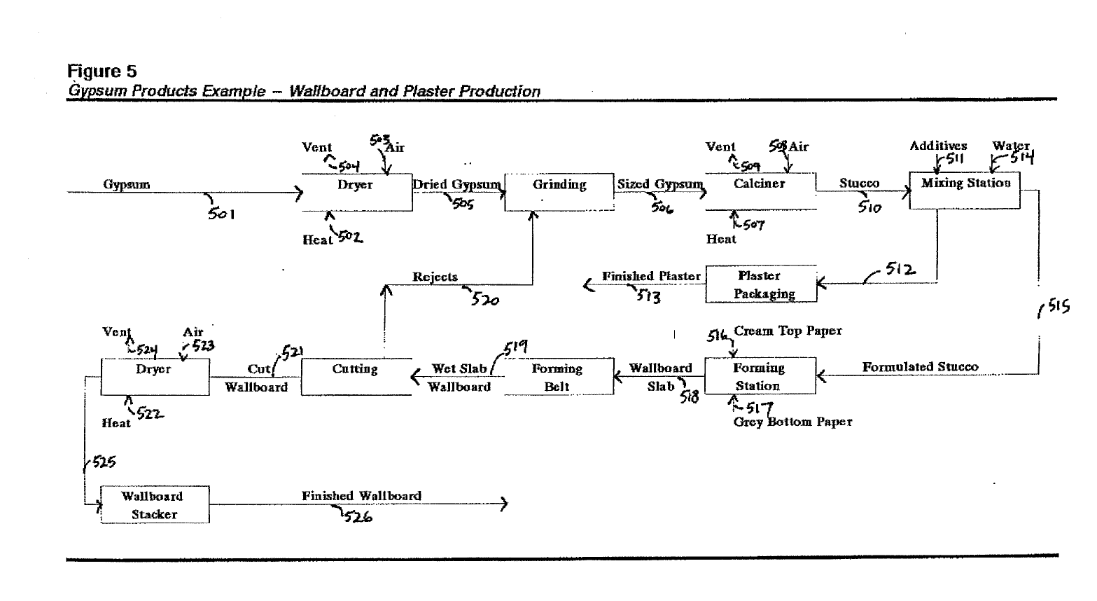

As seen in FIG. 5, blended gypsum 501 is preferably dried utilizing heat 502, with the introduction of air 503, to remove surface moisture with the moisture preferably directed to a vent 504. The dried gypsum 505 is optionally ground to produce a sized gypsum 506. This gypsum is then heated 507 in a calciner, typically through the direct firing of a fossil fuel but preferably utilizing methane gas generated in the anaerobic treatment of process water from the production of sugar and sugar products. The gypsum is heated 507, with the introduction of air 508, to liberate water bound to the calcium sulfate molecule with the moisture being directed preferably to a vent 509. This calcined gypsum, or stucco 510 is then preferably mixed with additives 511, depending on the type of wallboard or plaster being manufactured. These additives 511 include starch, potash, silicone, fiberglass, foaming agent and an accelerator for example, depending on the characteristics required for the final wallboard or plaster. Prior to the addition of water 514, mixed stucco, may be cooled and sized 512 before being directed to final packaging. The finished plaster 513 is then sold. Alternatively, the stucco, can be re-hydrated with water 514 to prepare the formulated stucco 515 for gypsum wallboard production. The formulated stucco 515 then preferably enters a forming station wherein cream top paper 516 and grey bottom paper 517 are added to the mixture to form gypsum wallboard. The wallboard slab 519 continues over a forming belt and hardens. The hardened wet slab board 519 is then preferably cut to lengths 521, with rejects 520 preferably recycled to the process. The cut boards 521 are dried with heat 522 and with introduction of air 523, with vapors being preferably directed to a vent 524. The finished wallboard 525 is preferably conveyed to a wallboard stacker and the finished stacked board 526 is warehoused for sale.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of producing sugars and gypsum from pulp and paper industry wastes, comprising:
mixing pulp and paper industry wastes with acid to neutralize any non-cellulosic acid reactive materials therein and at least partially de-crystallize cellulose and hemicellulose to form a gel that includes a solid material and a liquid portion;
diluting said gel to an acid concentration between about 10% and about 60% by weight;
heating said diluted gel, thereby at least partially hydrolyzing cellulose and hemicellulose contained in said gel;
separating said gel into an acidic liquid portion and a solid portion;
neutralizing the acidic liquid portion to precipitate a first gypsum byproduct; and
separating said neutralized liquid portion from said first gypsum byproduct.

2. The method of claim 1, further comprising pre-treating the pulp and paper industry wastes.

3. The method of claim 2, wherein pre-treating comprises drying the pulp and paper industry wastes.

4. The method of claim 3, wherein the pulp and paper industry wastes are dried to a moisture content between about 5% and about 40% by weight.

5. The method of claim 4, wherein the pulp and paper industry wastes are dried to a moisture content between about 10% and about 15%.

6. The method of claim 2, wherein pre-treating comprises commuting the pulp and paper industry wastes to particles having a size between about 0.05 mm and about 20 mm.

7. The method of claim 6, wherein pre-treating comprises commuting the pulp and paper industry wastes to particles having a size of about 5 mm.

8. The method of claim 2, wherein pre-treating comprises combining the pulp and paper industry wastes with a solution of sodium hydroxide to at least partially dissolve silica therein.

9. The method of claim 2, wherein pre-treating comprises combining the pulp and paper industry wastes with a ketone to at least partially dissolve lignin.

10. The method of claim 1, wherein the acid has an initial concentration of 20% -100%.

11. The method of claim 10, wherein the acid has an initial concentration of 70% -80%.

12. The method of claim 1, wherein the ratio of acid to cellulose and hemicellulose is between about 0.75:1 and about 5:1.

13. The method of claim 12, wherien the ratio of acid to cellulose and hemicellulose is about 1.3:1.

14. The method of claim 1, wherein the step of heating comprises heating the diluted gel to a temperature between about 50° C. and about 100° C.

15. The method of claim 14, wherein the step of heating comprises heating the diluted gel to a temperature between about 85° C. and 95° C.

16. The method of claim 1, wherien the step of diluting comprises diluting the acid to a concentration between about 20% and about 30% by weight.

17. The method of claim 1 further comprising bringing the acid-wastes mixture to a temperature between about 30° C. and 80° C. following the step of mixing.

18. The method of claim 17, further comprising bringing the acid-wastes mixture to a temperature between about 40° C. and 50° C. following the step of mixing.

19. The method of claim 1, wherein the step of heating is performed for a period between about 15 minutes and about 600 minutes.

20. The method of claim 19, wherein the step of heating is performed for a period between about 60 minutes and about 180 minutes.

21. The method of claim 1, wherein the pressure during a step selected from mixing and heating is between about 400 mm Hg vacuum and about 300 psi.

22. The method of claim 21, wherein a step selected from mixing and heating is performed at atmospheric pressure.

23. The method of claim 1, further comprising repeating the steps of mixing, diluting, heating, separating, and neutralizing with the solid portion.

24. The method of claim 1, wherein the step of neutralizing comprises combining the acidic liquid portion with a base material selected from calcium-bearing and non-calcium bearing.

25. The method of claim 24, wherein enough base material is added to the acidic liquid portion to achieve a concentration between 0.10 and 3.5 molar.

26. The method of claim 25, wherein enough base material is added to the acidic liquid portion to achieve a concentration between 0.75 and 0.95 molar.

27. The method of claim 24, further comprising recovering a resulting carbon dioxide byproduct.

28. The method of claim 24, wherein the base material comprises a member of calcium oxide, calcium hydroxide, calcium carbonate, and any combination of the above.

29. The method of claim 28, further comprising calcining and hydrating calcium carbonate to produce a member of calcium oxide and calciuim hydroxide.

30. The method of claim 29, wherein the steps of calcining and hydrating further produce a calcium-bearing grit, and wherein the method further comprises combining the calcium-bearing grit with the first gypsum byproduct to produce a combined gypsum byproduct.

31. The method of claim 24, wherein a pH of the neutralized liquid portion is between 0.01 and 13.5.

32. The method of claim 31, wherein a final pH of the neutralized liquid portion is 5.5.

33. The method of claim 24, wherein the step of neutralization is conducted at a temperature between about 20° C. and about 150° C.

34. The method of claim 33, wherein the step of neutralization is performed at about 50° C.

35. The method of claim 1, further comprising combusting the solid portion to generate heat and a residue.

36. The method of claim 35, further comprising combining the residue with the first gypsum byproduct to form a combined gypsum byproduct.

37. The method of claim 35, further comprising utilizing the heat in a process selected from a) the steps of mixing, diluting, heating, separating, and neutralizing, b) pretreating the pulp and paper wastes, c) calcining calcium carbonate to produce a member of calcium oxide or calcium hydroxide, d) heating the undiluted gel, e) processing a gypsum byproduct, f) sterilizing a sugar-containing liquid, g) concentrating a sugar-containing liquid, h) concentrating a liquid containing a sugar product, i) evaporating a liquid to crystallize a solute dissolved therein, j) drying a sugar product, and k) heating a mixture of a fermentation agent and a sugar-containing liquid.

38. The method of claim 1, wherein the acid is sulfuric acid.

39. The method of claim 38, further comprising producing sulfuric acid.

40. The method of claim 39, wherein the step of producing comprises combusting sulfur.

41. The method of claim 40, wherein the step of combustion results in a sulfurous gas byproduct, and wherein the method further comprises passing the sulfurous gas byproduct through a scrubber containing a calcium-bearing base material to form a used scrubber material; and combining the used scrubber material with the first gypsum byproduct to form a combined gypsum byproduct.

42. The method of claim 39, wherein the step of producing comprises processing sulfur-bearing gases, liquids, or solids.

43. The method of claim 39, wherein the step of producing results in a gas byproduct comprising sulfur, and wherein the method further comprises passing the gas byproduct through a scrubber containing a calcium-bearing base material to produce a used scrubber material; and combining the used scrubber material with the first gypsum byproduct to produce a combined gypsum byproduct.

44. The method of claim 1, further comprising:
passing the neutralized liquid portion through a cation exchange resin;
sterilizing the cation exchanged liquid portion;
incubating the sterilized liquid portion with a fermentation agent;
separating the liquid portion from the used fermentation agent;
combining the fermented liquid portion with a calcium-bearing base material to produce a calcium salt and a waste water product;
combining the calcium salt with sulfuric acid to produce a solution of a sugar product and a second gypsum byproduct; and
purifying and crystallizing the sugar product.

45. The method of claim 44, comprising:
combining the waste water portion with an anaerobic agent to produce a biogas; and
combusting the biogas to produce heat.

46. The method of claim 45, comprising utilizing the heat in a process selected from a) the steps of mixing, diluting, heating, separating, and neutralizing, b) pretreating the pulp and paper wastes, c) calcining calcium carbonate to produce a member of calcium oxide or calcium hydroxide, d) heating the undiluted gel, e) processing a gypsum byproduct, f) sterilizing a sugar-containing liquid, g) concentrating a sugar-containing liquid, h) concentrating a liquid containing a sugar product, i) evaporating a liquid to crystallize a solute dissolved therein, j) drying a sugar product, and k) heating a mixture of a fermentation agent and a sugar-containing liquid.

47. The method of claim 44, further comprising combining the first gypsum byproduct and the second gypsum byproduct to produce a combined gypsum byproduct.

48. The method of claim 44, further comprising combusting the used fermentation agent to produce heat.

49. The method of claim 48, comprising utilizing the heat in a process selected from a) the steps of mixing, diluting, heating, separating, and neutralizing, b) pretreating the pulp and paper wastes, c) calcining calcium carbonate to produce a member of calcium oxide or calcium hydroxide, d) heating the undiluted gel, e) processing a gypsum byproduct, f) sterilizing a sugar-containing liquid, g) concentrating a sugar-containing liquid, h) concentrating a liquid containing a sugar product, i) evaporating a liquid to crystallize a solute dissolved therein, j) drying a sugar product, and k) heating a mixture of a fermentation agent and a sugar-containing liquid.

50. The method of claim 1, further comprising combining mined gypsum with the first gypsum byproduct.

51. The method of claim 1, further comprising combining industrial calcium-bearing waste materials with the first gypsum byproduct to produce a combined gypsum byproduct.
